(19) United States
(12) Patent Application Publication
(10) Pub. No.: US 2009/0300495 A1
(43) Pub. Date: Dec. 3, 2009

(54) SYSTEM AND METHOD FOR AN ADAPTIVE WIZARD UTILITY FOR GRAPHICAL USER INTERFACES

(75) Inventors: Jeremy Ray Brown, Orem, UT (US); Jason Allen Sabin, Lehi, UT (US); Daniel Robert Timpson, Lehi, UT (US)

Correspondence Address: HAYNES AND BOONE, LLP;IP Section, 2323 Victory Avenue, Suite 700, Dallas, TX, 75219, US

(73) Assignee: NOVELL, INC., Provo, UT (US)

(21) Appl. No.: 12/131,468

(22) Filed: Jun. 2, 2008

(51) Int. Cl. G06F 3/048

(52) U.S. Cl. 715/708

(57) ABSTRACT

System and method for implementing an adaptive wizard utility for a graphical user interface (“GUI”) are described. In one embodiment, the method comprises, responsive to presentation of a page of the wizard utility to a user, monitoring user activity in connection with the page; analyzing the user activity to determine a current performance designation of the user; and modifying at least one page of the wizard utility based on the current performance designation of the user.

### BACKGROUND

In computer parlance, a “wizard” or “assistant” is a utility within an application that typically comprises a series of dialog boxes or web pages that are presented to a user in a particular sequence to lead the user through a series of steps to complete a particular task. For example, a word processing program may include “letter wizard” for guiding a user through the steps involved in preparing various forms of correspondence. Ideally, a wizard is designed to assist a user in completing a task in a timely and accurate manner and is especially useful in cases in which the task is unusually complex or unfamiliar to the user.

In general, when using a wizard to complete a task, a user must complete each step presented by the wizard before he or she will be allowed to proceed to the next step. For users who have previously performed the wizard-assisted task, the inability to speed up or skip steps may be a source of frustration. On the other hand, users who are unfamiliar with the wizard-assisted task or who are novice computer users in general may need more assistance than typically offered by the wizard and may become frustrated by the lack of information presented.

### SUMMARY

One embodiment is a method for implementing an adaptive wizard utility for a graphical user interface (“GUI”). The method comprises, responsive to presentation of a page of the wizard utility to a user, monitoring user activity in connection with the page; analyzing the user activity to determine a current performance designation of the user; and modifying at least one page of the wizard utility based on the current performance designation of the user.

### BRIEF DESCRIPTION OF THE DRAWINGS

FIG. 1 is a block diagram of a network in which an adaptive wizard utility for graphical user interfaces (“GUIs”) in accordance with one embodiment may be implemented.

FIG. 2 is flowchart of a method of implementing an adaptive wizard utility for GUIs in accordance with one embodiment.

### DETAILED DESCRIPTION

To better illustrate the advantages and features of the embodiments, a particular description of several embodiments will be provided with reference to the attached drawings. These drawings, and other embodiments described herein, only illustrate selected aspects of the embodiments and are not intended to limit the scope thereof. Further, despite reference to specific features illustrated in the example embodiments, it will nevertheless be understood that these features are not essential to all embodiments and no limitation of the scope thereof is thereby intended. Any alterations and further modifications in the described embodiments, and any further applications of the principles of the embodiments as described herein are contemplated as would normally occur to one skilled in the art. Furthermore, some items are shown in a simplified form, and inherently include components that are well known in the art. Further still, some items are illustrated as being in direct connection for the sake of simplicity and clarity. Despite the apparent direct connection, it is understood that such illustration does not preclude the existence of intermediate components not otherwise illustrated.

As used herein, the phrase “wizard” is broadly defined to include any software utility that employs a series of pages (as defined below) presented in a particular order to guide a user through a series of steps in performing a particular task.

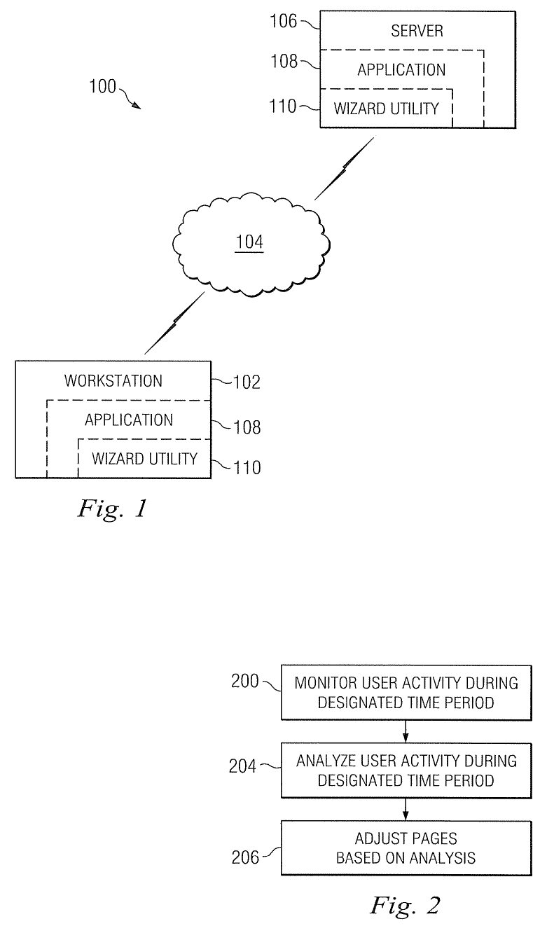

FIG. 1 is a block diagram of a network 100 in which a system for implementing an adaptive wizard utility for graphical user interfaces (“GUIs”) in accordance with one embodiment may be implemented. As shown in FIG. 1, the network 100 comprises a workstation 102 which may be connected via an Internet connection 104 to a remote server 106. As described in greater detail below, a user may interact with applications 108 executing on the workstation 102 and/or the remote server 106 via corresponding GUIs presented on a display of the workstation 102. It will be recognized that, in some embodiments, a GUI may comprise one or more web pages presented on the display of the workstation 102. As will also be recognized, the applications 108 comprise computer-executable instructions stored on one or more computer-readable media (e.g., a hard drive, compact disk, memory device) associated with the workstation 102 and/or server 106.

As will also be described in greater detail below, in accordance with one embodiment, each of the applications 108 includes a wizard utility 110 configured to monitor and adapt to a performance level of the user in assisting the user in performing a wizard-assisted task. The wizard utility 110 assists the user in performing steps associated with the task using dialog boxes, web pages, or other GUI elements (hereinafter collectively referred to as “pages”), which are sequentially presented on the display of the workstation 102.

It will be recognized that, as used herein, “wizard” is broadly defined to include administration user interfaces or any other GUI utility in which pages are presented sequentially, in addition to utilities commonly referred to as wizards, whether those utilities are implemented on the workstation 102 or server 106.

FIG. 2 is a flowchart illustrating operation of the wizard utility 110 for performing a wizard-assisted task in accordance with one embodiment. In step 200, responsive to presentation to the user of a page comprising a step of the wizard-assisted task, user activity in response to the presentation of the page is monitored. In general, this step involves capturing user events that occur within a designated time period relative to initial presentation of the page on the display, such as within the first 30 seconds. As used herein, a “user event” is any event that evinces a user's attempt to interact or respond to information displayed in connection with the step, such as mouse movements, mouse clicks, trackball movements, and key strokes, for example. In step 204, user activity during the designated time period is analyzed. In one embodiment, the analysis performed in step 204 comprises determining the number of user events that have occurred within the time period (from step 200) and comparing that value to one or more thresholds indicating performance of the user.

For example, in one embodiment, five thresholds and corresponding performance designations are defined: a “FASTEST” performance designation corresponds to ten user events during the designated time period, a “FAST” performance designation corresponds to five user events during the designated time period, a “SLOW” performance designation corresponds to two user events during the designated time period, a “SLOWER” performance designation corresponds to 0.5 user events during the designated time period, and a “SLOWEST” performance designation corresponds to less than 0.1 user events during the designated time period.

Additionally or alternatively, the types of user events (e.g., mouse clicks vs. keystrokes), in addition to simply the raw number thereof, may be considered in performing the analysis of step 204. In this embodiment, different types of user events may be weighted differently in determining a user's performance designation. Still further, the analysis of step 204 may also take into account the complexity of the features that are being used, with more use of complex features being weighted more heavily than use of simpler features in determining a user's performance designation.

In step 206, presentation of one or more pages of the wizard utility are adjusted in accordance with the analysis conducted in step 204. For example, continuing with the example set forth above in connection with step 204, assuming a determination has been made in step 204 that the user is FAST, the presentation of the wizard may be adjusted to remove unnecessary information and/or combine selection fields that have been determined to be the most important for the current page, as well as subsequent pages. Assuming a determination has been made in step 204 that the user is FASTEST, subsequent pages of the wizard utility may be removed and/or information thereon consolidated to include only the most important selection fields and check boxes in the minimum number of pages. Additionally or alternatively, entire pages may be rebuilt to include only the most advanced options.

Assuming a determination has been made in step 204 that the user is SLOW, the presentation of the wizard utility is adjusted so that a pop-up is presented to the user providing examples of how the user may progress more quickly through the pages. Additionally or alternatively, the pop-up may include a link to a help function. Assuming a determination has been made in step 204 that the user is SLOWER, the presentation of the wizard utility is adjusted to open a browser window presenting documentation covering relevant topics. Additionally or alternatively, buttons may be displayed that the user may click to initiate examples and other options. Assuming a determination has been made in step 204 that the user is SLOWEST, the presentation of the wizard utility is adjusted to display a chat window for enabling the user to communicate with a live support technician. Additionally or alternatively, a link may be initiated to enable the support representative to access the user's workstation directly in order to provide additional assistance.

In one embodiment, a user's performance designation may change, depending on the page of the wizard that the user is on. Accordingly, the process illustrated in FIG. 2 executes continuously throughout presentation of the wizard utility, with user events being continuously monitored an analyzed and the presentation of the wizard being adjusted based on the results of the analysis.

Additionally or alternatively, data dumps of totals for sections and pages that users experienced as they progressed through the wizard may be made available. These totals may be provided as a simple text file or log indicating on what pages/in what sections users spent the most time. Load time for each page may also be included in this information to enable an administrator to determine whether the wizard is working properly and where it can be sped up. This information can also be provided to GUI designers to enable the designers to optimize the GUI design of the wizard.

Additionally or alternatively, overall page navigations and number of times a user accesses a page may be captured and stored by identity/IP address. In this manner, the wizard utility may be customized for a particular user instead of being configured for a generic “typical” user. Page settings may be customized and stored on a per-user basis for each page. In this manner, the process illustrated in FIG. 2 is rendered identity-aware and is thereby able to provide user-specific solutions across a network for various users so that the configuration of the wizard utility matches the particular user's performance.

Additionally or alternatively, feedback information may be captured responsive to a user's responding to an instruction to enter a keystroke or sequence of key strokes or click on a designated feedback icon. This feedback information can then be used to further adjust the performance of the wizard utility.

Additionally or alternatively, a stub may be authenticated and initiated to track all the data on the user using a user ID or IP address. The data for the entire wizard-assisted task is either captured in a file or kept live in a database on a per-user basis.

Additionally or alternatively, adjustments to the overall system may be made manually by a user at any point during use, for example, by using keystrokes to disable the system or increase the assistance and responsiveness thereof.

While the preceding description shows and describes one or more embodiments, it will be understood by those skilled in the art that various changes in form and detail may be made therein without departing from the spirit and scope of the present disclosure. For example, various steps of the described methods may be executed in a different order or executed sequentially, combined, further divided, replaced with alternate steps, or removed entirely. In addition, various functions illustrated in the methods or described elsewhere in the disclosure may be combined to provide additional and/or alternate functions. Therefore, the claims should be interpreted in a broad manner, consistent with the present disclosure.

What is claimed is:

1. A method for implementing an adaptive wizard utility for a graphical user interface (“GUI”), the method comprising:
responsive to presentation of a page of the wizard utility to a user, monitoring user activity in connection with the page;
analyzing the user activity to determine a current performance designation of the user;
modifying at least one page of the wizard utility based on the current performance designation of the user.

2. The method of claim 1 wherein the monitoring further comprises tracking a number of user events that occur within a designated time period and wherein the analyzing further comprises comparing the tracked number of user events to at least one threshold.

3. The method of claim 1 further comprising receiving an indication of a default performance designation from the user, wherein the default performance designation is used in place of the current performance designation in the modifying at least one page.

4. The method of claim 1 wherein the modifying further comprises deleting information from the at least one page responsive to the current performance designation falling within a first range.

5. The method of claim 1 wherein the modifying further comprises adding information to the at least one page responsive to the current performance designation falling within a second range.

6. The method of claim 1 wherein the modifying further comprises combining the at least one page with at least one other page responsive to the current performance designation falling within a third range.

7. The method of claim 1 wherein the modifying further comprises opening a real time connection via a communications channel for enabling the user to interact with a knowledge entity responsive to the current performance designation falling within a fourth range.

8. The method of claim 1 wherein the modifying further comprises providing a mechanism for enabling the user to electronically access additional information responsive to the current performance designation falling within a fifth range.

9. The method of claim 1 further comprising:
storing the user's performance designation in connection with the user, the adding information to the at least one page, wherein the stored performance designation is used in presenting the wizard utility during subsequent use thereof.

10. The method of claim 1 wherein the monitoring, analyzing, and modifying are performed in connection with multiple users, the method further comprising compiling information collected during the monitoring and analyzing and making the compiled information available to at least one third party.

11. A system for implementing an adaptive wizard utility for a graphical user interface (“GUI”), the system comprising:
a workstation having a display;
means to presentation of a page of the wizard utility to a user via the display for monitoring user activity in connection with the page;
means for analyzing the user activity to determine a current performance designation of the user; and
means for modifying at least one page of the wizard utility based on the current performance designation of the user.

12. The system of claim 11 wherein the means for monitoring further comprises means for tracking a number of user events that occur within a designated time period and the means for analyzing further comprises means for comparing the tracked number of user events to at least one threshold.

13. The system of claim 11 wherein the means for modifying further comprises:
means for deleting information from the at least one page responsive to the current performance designation falling within a first range;
means for adding information to the at least one page responsive to the current performance designation falling within a second range; and
means for combining the at least one page with at least one other page responsive to the current performance designation falling within a third range.

14. The system of claim 11 wherein the means for modifying further comprises means for opening a real time connection via a communications channel for enabling the user to interact with a knowledge entity responsive to the current performance designation falling within a fourth range and means for providing a mechanism for enabling the user to electronically access additional information responsive to the current performance designation falling within a fifth range.

15. The system of claim 11 further comprising means for storing the user's performance designation in connection with the user, the adding information to the at least one page, wherein the stored performance designation is used in presenting the wizard utility during subsequent use thereof.

16. A computer program product comprising a computer-readable medium having stored thereon computer-executable instructions for d implementing an adaptive wizard utility for a graphical user interface (“GUI”), the instructions comprising:
instructions for presenting a page of the wizard utility to a user;
instructions for monitoring user activity in connection with the presented page;
instructions for analyzing the user activity to determine a current performance designation of the user; and
instructions for modifying at least one page of the wizard utility based on the current performance designation of the user.

17. The computer program product of claim 16 wherein the instructions for monitoring further comprise instructions for tracking a number of user events that occur within a designated time period and the instructions for analyzing further comprise instructions for comparing the tracked number of user events to at least one threshold.

18. The computer program product of claim 16 wherein the instructions for modifying further comprises:
instructions for deleting information from the at least one page responsive to the current performance designation falling within a first range;
instructions for adding information to the at least one page responsive to the current performance designation falling within a second range; and
instructions for combining the at least one page with at least one other page responsive to the current performance designation falling within a third range.

19. The computer program product of claim 16 wherein the instructions for modifying further comprise:
instructions for opening a real time connection via a communications channel for enabling the user to interact with a knowledge entity responsive to the current performance designation falling within a fourth range; and
instructions for modifying further comprises means for providing a mechanism for enabling the user to electronically access additional information responsive to the current performance designation falling within a fifth range.

20. The computer program product of claim 16 wherein the computer readable medium further has stored thereon instructions for storing the user's performance designation in connection with the user, the adding information to the at least one page, wherein the stored performance designation is used in presenting the wizard utility during subsequent use thereof.
